(19) United States
(12) Patent Application Publication
(10) Pub. No.: US 2019/0293937 A1
(43) Pub. Date: Sep. 26, 2019

(54) AUGMENTED REALITY DISPLAY DEVICE AND METHOD, AND AUGMENTED REALITY GLASSES

(71) Applicant: BOE TECHNOLOGY GROUP CO., LTD., Beijing (CN)

(72) Inventor: Sen Ma, Beijing (CN)

(21) Appl. No.: 16/134,739

(22) Filed: Sep. 18, 2018

(30) Foreign Application Priority Data
Mar. 20, 2018 (CN) 201810230767.1

(51) Int. Cl. G02B 27/01; G06T 19/00; G02B 27/00

(52) U.S. Cl. CPC G02B 27/0172; G06T 19/006; G02B 2027/0138; G02B 2027/0178; G02B 27/0093

(57) ABSTRACT

The present disclosure provides an augmented reality display device. The augmented reality display device includes an adjustable light transmissive sheet, a spatial three-dimensional reconstruction component, and a control unit. The adjustable light transmissive sheet includes a plurality of pixels, the light transmission of each of the plurality of pixels being controllable. The spatial three-dimensional reconstruction component can obtain the depth value of each real point of the real scene in the user's field of view. The control unit can compare the depth value of the virtual point displayed in the same pixel with that of the real point. When the depth value of the real point is greater than that of the virtual point, the pixel is controlled to be opaque; and when the depth value of the real point is smaller than that of the virtual point, the pixel is controlled to be transparent.

### CROSS REFERENCE

The present application is based upon and claims priority to Chinese Patent Application No. 201810230767.1, filed on Mar. 20, 2018, and the entire contents thereof are incorporated herein by reference.

### TECHNICAL FIELD

The present disclosure relates to an augmented reality display device and method, and augmented reality glasses.

### BACKGROUND

Augmented reality (AR) technology is a projection method in which virtual objects and virtual scenes are superimposed and displayed in the real world. When the virtual scene and the real scene are superimposed together, the virtual object and the real object will be shielded by each other because of their different positions in the space, and their different distances from the user, i.e., their different depth values.

The above information disclosed in this Background of the disclosure is only used to enhance an understanding of the background of the disclosure, and thus it may include information that does not constitute the prior art known to those skilled in the art.

### SUMMARY

According to an aspect of the disclosure, an augmented reality display device includes an adjustable light transmissive sheet including a plurality of pixels. Light transmission of each of the plurality of pixels is controllable. The augmented reality display device includes a spatial three-dimensional reconstruction component, configured to obtain a depth value of each real point of a real scene in a user's field of view. The augmented reality display device includes a control unit, configured to compare a depth value of a virtual point displayed in a pixel with the depth value of the real point of the real scene corresponding to the pixel. When the depth value of the real point is greater than the depth value of the virtual point, the pixel is controlled to be opaque. When the depth value of the real point is smaller than the depth value of the virtual point, the pixel is controlled to be transparent.

In one exemplary arrangement of the disclosure, the augmented reality display device further includes a virtual scene generator electrically connected to the control unit, and configured to not generate a virtual scene at the pixel corresponding to the virtual point when the depth value of the real point is smaller than the depth value of the virtual point.

In one exemplary arrangement of the disclosure, the spatial three-dimensional reconstruction component includes
a light emitter, configured to emit light, the light being reflected by the real scene in the user's field of view to form reflected light. The augmented reality display device includes an optical receiver configured to receive the reflected light and determine the depth value of each real point of the real scene in the user's field of view according to the reflected light.

In one exemplary arrangement of the disclosure, the light includes structured light.

In one exemplary arrangement of the disclosure, the structured light includes standard stripe or grid light.

In one exemplary arrangement of the disclosure, the augmented reality display device further includes
an eye movement information capture device, configured to monitor eye movement information of the user in real time. The augmented reality display device includes
the control unit is configured to determine a sight of the user according to the eye movement information, to determine a pixel corresponding to the real point.

In one exemplary arrangement of the disclosure, the augmented reality display device further includes
a lens, configured to transmit the real scene and reflect a virtual scene to the user, the lens being attached to the adjustable light transmissive sheet.

In one exemplary arrangement of the disclosure, the adjustable light transmissive sheet includes a liquid crystal light transmissive sheet.

According to an aspect of the disclosure, there is provided an augmented reality glasses. The augmented reality display device includes
the augmented reality display device of any one of the above aspects, a frame, and a temple.
   The adjustable light transmissive sheet is provided in the frame, the spatial three-dimensional reconstruction component is provided on the frame, and the control unit is provided at the temple.

According to an aspect of the disclosure, there is provided an augmented reality display method. The method includes
obtaining a depth value of each real point of a real scene in a user's field of view. The method includes receiving a depth value of each virtual point of a virtual scene. The method includes
comparing the depth value of the virtual point displayed in a pixel with the depth value of the real point of the real scene corresponding to the pixel. When the depth value of the real point is greater than the depth value of the virtual point, the pixel is controlled to be opaque. When the depth value of the real point is smaller than the depth value of the virtual point, the pixel is controlled to be transparent.

In one exemplary arrangement of the disclosure, the augmented reality display method further includes
not generating a virtual scene at the pixel corresponding to the virtual point when the depth value of the real point is smaller than the depth value of the virtual point.

In one exemplary arrangement of the disclosure, obtaining the depth value of each real point of the real scene in the user's field of view includes emitting light, the light being reflected by the real scene in the user's field of view to form reflected light, and
receiving the reflected light and determining the depth value of each real point of the real scene in the user's field of view according to the reflected light.

In one exemplary arrangement of the disclosure, the augmented reality display method further includes monitoring eye movement information of the user in real time, and determining a sight of the user according to the eye movement information, to determine a pixel corresponding to the real point.

It is to be understood that both the foregoing general description and the following detailed description are exemplary and explanatory only and are not restrictive of the disclosure, as claimed.

This section provides a summary of various implementations or examples of the technology described in the disclosure, and is not a comprehensive disclosure of the full scope or all features of the disclosed technology.

### BRIEF DESCRIPTION OF THE DRAWINGS

The above and other features and advantages of the present disclosure will become more obvious by the detailed description of the exemplary arrangements with reference to the drawings.

FIG. 1 is a principle schematic diagram of a video perspective augmented reality display;

FIG. 2 is a principle schematic diagram of an optical perspective augmented reality display;

FIG. 3 is a schematic block diagram of electrical connections of an augmented reality display device of the present disclosure;

FIG. 4 is a schematic diagram of a display effect of an augmented reality display device of the present disclosure;

FIG. 5 is a schematic diagram of another display effect of an augmented reality display device of the present disclosure;

FIG. 6 is a specific schematic flowchart of an augmented reality display device of the present disclosure;

FIG. 7 is a schematic structure diagram of one exemplary arrangement of an augmented reality glasses of the present disclosure; and

FIG. 8 is a block flowchart of an augmented reality display method of the present disclosure.

### REFERENCE NUMERALS IN THE DRAWINGS

1. Display screen; 2. Camera; 3. Computer; 4. Transflective film; 5. Eye 6. Display component; 61. Lens; 62. Adjustable light transmissive sheet; 7. Eye movement information capture device; 8. Light emitter; 9. Light receiver; 10. Control unit; 11. Frame; 12. Temple; V. Virtual object; R. Real object.

### DETAILED DESCRIPTION

Exemplary arrangements will now be described more fully with reference to the accompanying drawings. However, the exemplary arrangements can be embodied in a variety of forms, and should not be construed as being limited to the arrangements set forth herein. In contrast, these arrangements are provided to make the present disclosure comprehensive and complete, and comprehensively convey the concepts of the exemplary arrangements to those skilled in the art. The same reference numerals in the drawings denote the same or similar structures, and thus their detailed description will be omitted.

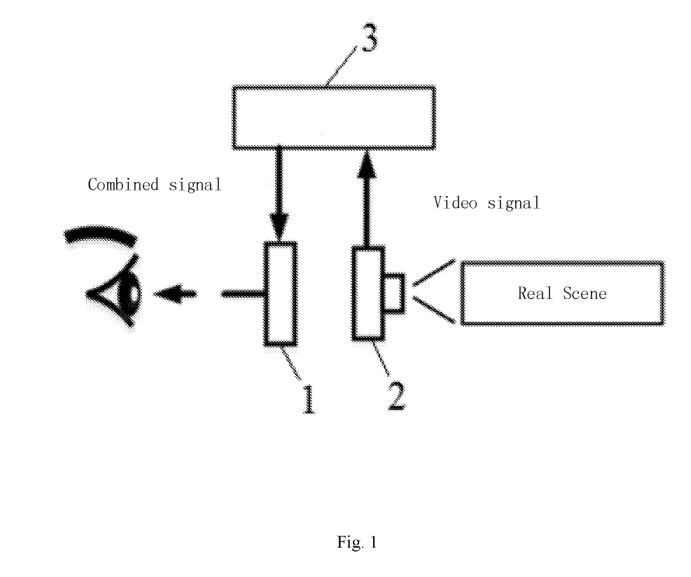

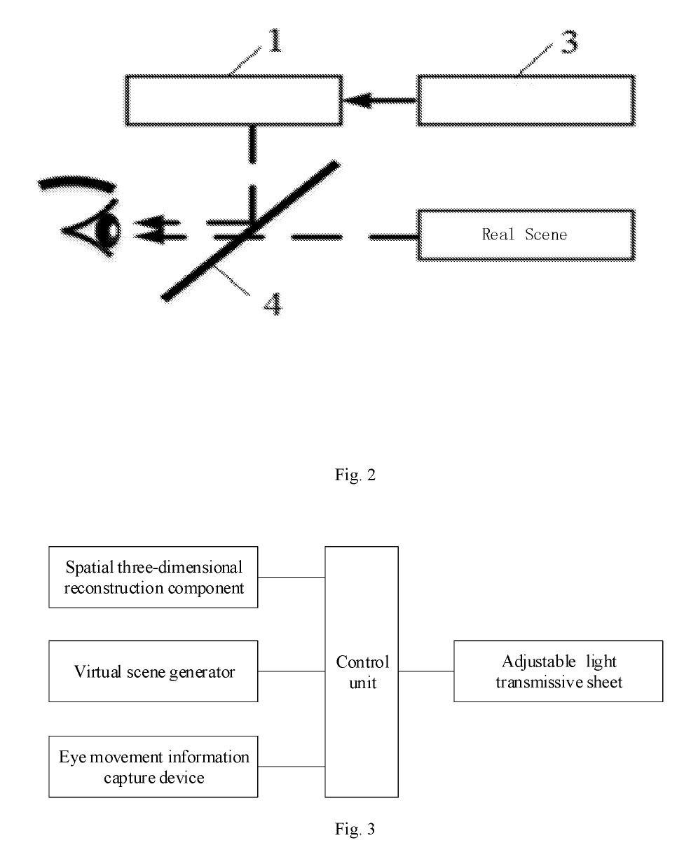

Augmented reality (AR) technology can be classified into two types of a video perspective AR and an optical perspective AR according to the implementing principle. Referring to the schematic diagram of the video perspective augmented reality display shown in FIG. 1, the user's natural field of view is shield by the display screen 1, the camera 2 captures the image of the real scene, and the computer 3 uses the video synthesis technology to superimpose the virtual scene image with the real scene image. The virtual reality scene is presented to the user through the display screen 1. Referring to the optical perspective display augmented reality display principle diagram shown in FIG. 2, the display device generally has a transflective film 4, and the user's natural field of view is unshielded, and the real scene can be directly viewed through the display device, and the virtual scene generated by the computer 3 is displayed on the display screen 1 and reflected into the user's eyes by the transflective film 4 to realize the superposition of the virtual scene with the real scene.

Referring to the schematic block diagram of the electrical connections of the augmented reality display device of the present disclosure shown in FIG. 3, the present disclosure firstly discloses an augmented reality display device, the augmented reality display device may include an adjustable light transmissive sheet, a spatial three-dimensional reconstruction component and a control unit or the like. The adjustable light transmissive sheet may include a plurality of pixels, the light transmission of each of the plurality of pixels can be controlled; the spatial three-dimensional reconstruction component may be used to obtain the depth value of each real point of the real scene in the user's field of view; the control unit may receive the depth value of each virtual point of the virtual scene, and may be used to compare the depth value of the virtual point displayed in the same pixel with that of the real point, when the depth value of the real point is greater than that of the virtual point, the pixel is controlled to be opaque; when the depth value of the real point is smaller than that of the virtual point, the pixel is controlled to be transparent.

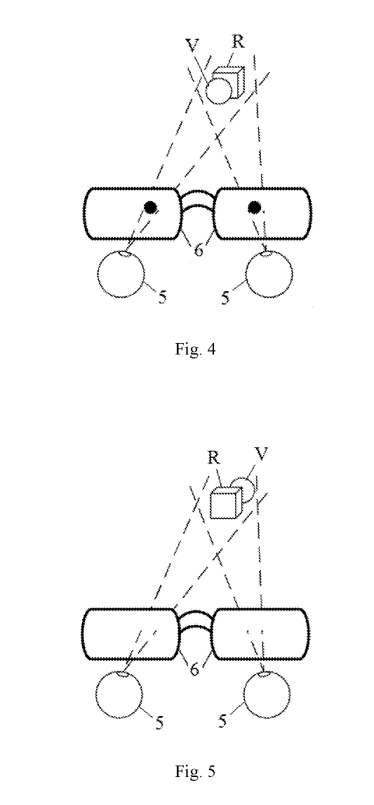

Referring to FIGS. 4, 5 and 7, in this exemplary arrangement, the display component 6 may include a lens 61 and an adjustable light transmissive sheet 62. The lens 61 is provided as a transflective lens, that is, the lens 61 can transmit the light of the real scene to the user's eyes 5, and can reflect the light of the virtual scene to the user's eyes 5, such that the user can simultaneously see the real scene and the virtual scene. The adjustable transparent sheet 62 is attached to the lens 61, and the adjustable transparent sheet 62 is attached to the side of the lens 61 away from the user, that is, the light of the real scene first passes through the adjustable transparent sheet 62 and then passes through the lens 61. In addition, a transflective film can be provided on the side of the adjustable light-transmissive sheet 62 close to the user, and the transflective film can achieve the effect of transmitting light of the real scene and reflecting the light of the virtual scene, which falls in the scope of the disclosure as claimed.

The adjustable light transmissive sheet 62 may include a plurality of pixels, the light transmission of each of the plurality of pixels can be controlled. When a pixel operates in a light transmitting state, the user can see an external real scene through the position of the pixel. When a pixel operates in an opaque state, the user's field of view at this position of the pixel is shielded, and the user cannot see the real scene in this direction.

By controlling the light transmittance of each pixel, it is possible to control whether a real scene is visible at each pixel, thus presenting a correct shielding relationship between the real scene and the virtual scene. The adjustable light transmissive sheet 62 may be a liquid crystal light transmissive sheet, and the light transmission of each of which can be controlled. For example, the adjustable light transmissive sheet 62 may have a liquid crystal structure, and each pixel is a liquid crystal light valve. By controlling the driving voltage of each pixel, the light transmittance of each pixel can be independently controlled. However, the present disclosure is not limited thereto, and in other arrangements of the present disclosure, other pixelated or matrixed structures may also be used, in which each pixel can be individually controlled.

The spatial three-dimensional reconstruction component may include a light emitter 8 and a light receiver 9 or the like. The light emitter 8 may be used to emit light, and the real scene in the user's field of view reflects the light to form the reflected light. The light receiver 9 may be used to receive the reflected light and determine a depth value of each real point of the real scene in the user's field of view according to the reflected light.

The spatial three-dimensional reconstruction component can determine the depth value of each real point of the real scene by using the time of flight (TOF) method, the light emitter 8 can emit a light pulse to the real scene, the real scene reflects the light to form the reflected light, and the light receiver 9 receives the reflected light. The depth value of each real point of the real scene is obtained by detecting the round trip time of the light pulse.

The spatial three-dimensional reconstruction component can also determine the depth value of each real point of the real scene by using the structured light projection method, the light emitter 8 can project the structured light to the real scene, the real scene reflects the structured light, and the light receiver 9 receives the reflected structure. The reflected structured light is stripped-deformed by the unevenness of the target, and the shape and the spatial coordinate of the target can be obtained through an analysis process. The analysis processing method are already known and will not be described here. The depth value of each real point of the real scene in the user's field of view is obtained by the spatial coordinate. The structured light may be a standard stripe or grid light, and so on.

The spatial three-dimensional reconstruction component may further determine the depth value of each real point of the real scene in the user's field of view by using interferometry, stereo vision, depth from defocus measurements or the like, which will not be described here.

The augmented reality display device further includes a virtual scene generator for generating a virtual scene, and the virtual scene is reflected by the lens 61 to the user. The virtual scene generator can be a display screen, a projection device, or the like. The virtual scene generator is electrically connected to the control unit, when the depth value of the real point is smaller than the depth value of the virtual point, the pixel corresponding to the virtual point is controlled such that the virtual scene is not generated. It is possible to prevent the virtual scene from being displayed in the case that the real scene shields the virtual scene and leading to confusion for the user to determine the position.

The control unit 10 may receive the depth value of each virtual point of the virtual scene, and may be configured to compare the depth value of the virtual point displayed in the same pixel with the depth value of the corresponding real point. The following two cases may be obtained after the comparison.

When the depth value of the real point is greater than the depth value of the virtual point, it is determined that virtual scene shields the real scene at the pixel, and the pixel is controlled to be opaque such that the user can see the virtual scene instead of the real scene. Referring to the schematic diagram of a display effect of an augmented reality display device of the present disclosure shown in FIG. 4, the cube is a real object R and the sphere is a virtual object V. The pixels of the adjustable light-transmissive sheet 62 corresponding to the portion of the cube which is shielded by the sphere are operated in an opaque state, and the user only sees the unshielded portion of the cube.

When the depth value of the real point is smaller than the depth value of the virtual point, it is determined that real scene shields the virtual scene at the pixel, and the virtual scene generator is controlled to re-draw the virtual image, such that in the new virtual image, the virtual image at the pixel is not displayed, and thus the user can see the real scene instead of the virtual scene. Referring to the schematic diagram of a further display effect of an augmented reality display device of the present disclosure shown in FIG. 5, the cube is a real object R and the sphere is a virtual object V. The user only sees the portion of the sphere which is not be shield.

The augmented reality display device may further include an eye movement capture device 7, the eye movement capture device 7 is configured to monitor the eye movement information of the user in real time, and the control unit 10 determines the sight of the user according to the eye movement information, in order to determine a pixel corresponding to the real point.

Specifically, the eye movement information capture device 7 tracks the eye movement of the user in real time, and determines the direction of the sight of the user. The control unit 10 can determine the pixel of the adjustable light-transmissive sheet 62 corresponding to each real point in the real scene in the user's field of view according to the connected line of the sight and each point on the three-dimensional model of the real scene, then control whether the pixel is transparent or not, to control whether the user can view the point on the real scene. The eye movement information capture device 7 can accurately determine the field of view of the user, so that the control unit can only determine and control the pixels in the field of view range, thus reducing the calculation amount of the control unit and improving the operation speed.

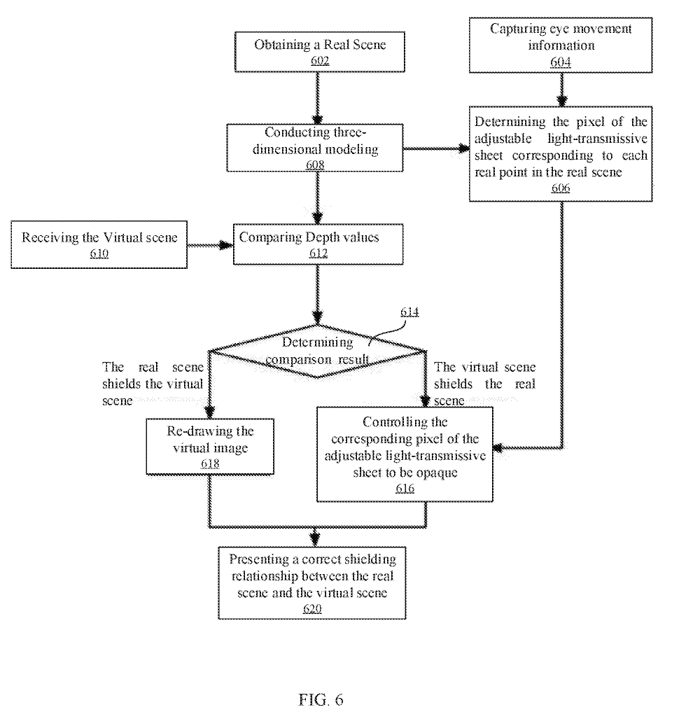

Referring to the specific schematic flowchart of an augmented reality display device of the present disclosure shown in FIG. 6, the operation process of the augmented reality display device of the present disclosure is described in detail below.

The spatial three-dimensional reconstruction component conduct a three-dimensional modeling for the real scene in the user's field of view to obtain the depth value of each real point of the real scene at 602. The eye movement information capture device 7 tracks the eye movement of the user in real time at 604, and determines the direction of the sight of the user at 606. The control unit 10 can determine the pixel of the adjustable light-transmissive sheet 62 corresponding to each real point in the real scene in the user's field of view according to a connecting line between the sight and each point on the three-dimensional model of the real scene at 608. Concurrently, the virtual scene generator generates the virtual scene and the depth value of each virtual point of the virtual scene. The control unit 10 receives the depth value of each virtual point of the virtual scene at 610, and compares the depth value of the virtual point displayed in the same pixel with the depth value of the real point at 612. When the depth value of the real point is determined to be greater than the depth value of the virtual point at 614, it is determined that the virtual scene shields the real scene at this pixel, and the pixel is controlled to be opaque at 616, so that the user can see the virtual scene instead of the real scene. When the depth value of the real point is determined to be smaller than the depth value of the virtual point at 614, it is determined that the real scene shields the virtual scene at the pixel, and the virtual scene generator is controlled to re-draw the virtual image at 618, such that in the new virtual image, the virtual image at the pixel is not displayed, and thus the user can see the real scene instead of the virtual scene. At 620, a correct shielding relationship between the real scene and virtual scene is presented.

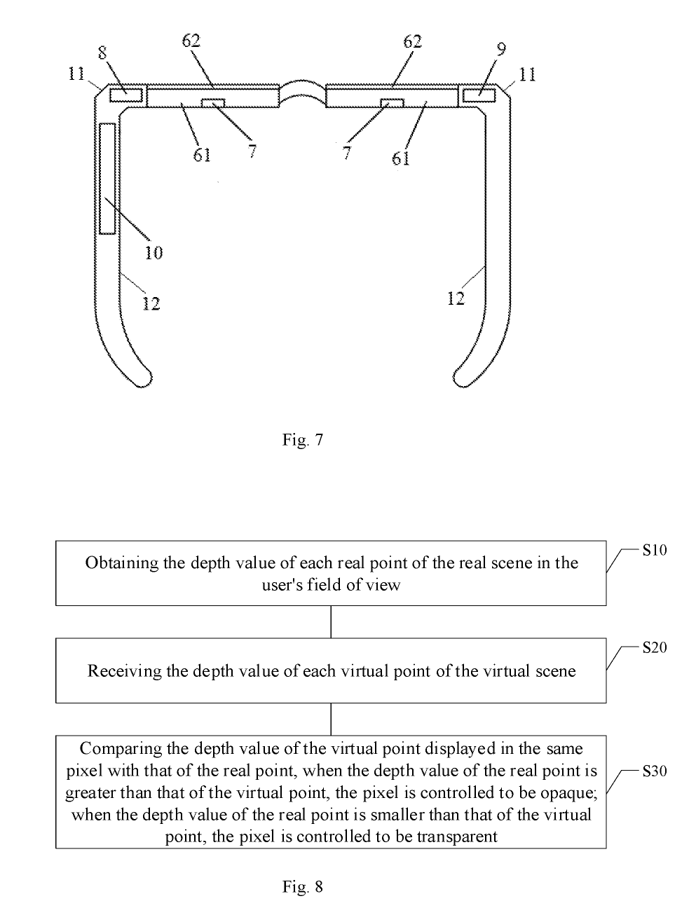

In addition, the present disclosure further provides an augmented reality glasses. Referring to the schematic structure diagram of one exemplary arrangement of the augmented reality glasses shown in FIG. 7, the augmented reality glasses includes the above augmented reality display device. The specific structure and the operation process of the augmented reality display device have been described above, and will not be described herein again.

In this exemplary arrangement, the augmented reality glasses may include two frames 11 and two temples 12. The display assembly 6 is provided in the frame 11, for example, the lens 61 and the adjustable light-transmissive sheet 62 are provided the frame 11. The spatial three-dimensional reconstruction component is provided on the frame 11, for example, the light emitter 8 is provided on one frame 11, and the light receiver 9 is provided on the other frame 11 symmetrically with the light emitter 8. The control unit 10 is provided on the temple 12. The eye movement information capture device 7 may include two units, which are respectively provided on the upper frame sides of the two frames 11.

It will be understood by those skilled in the art that the augmented reality display device can also be provided on a helmet or a mask to form a head mounted augmented reality display device. Of course, it can also be used in automobiles, aircrafts, etc., for example, in a head up display (HUD), or in a flight aid instrument used on an aircraft.

Further, the present disclosure further provides an augmented reality display method corresponding to the augmented reality display device described above. Referring to the block flowchart of the augmented reality display method shown in FIG. 8, the augmented reality display method may include the following:

At 10, the depth value of each real point of the real scene in the user's field of view is obtained;

at 20 the depth value of each virtual point of the virtual scene is received; and

at 30, the depth value of the virtual point displayed in the same pixel is compared with that of the real point, when the depth value of the real point is greater than that of the virtual point, the pixel is controlled to be opaque; when the depth value of the real point is smaller than that of the virtual point, the pixel is controlled to be transparent.

In this exemplary arrangement, the augmented reality display method further includes: when the depth value of the real point is smaller than the depth value of the virtual point, the virtual point corresponding to the pixel is controlled such that the virtual scene is not generated.

In this exemplary arrangement, obtaining the depth value of each real point of the real scene in the user's field of view includes: emitting light, and the real scene in the user's field of view reflects the light to form the reflected light; receiving the reflected light and determining a depth value of each real point of the real scene in the user's field of view according to the reflected light.

In this exemplary arrangement, the augmented reality display method further includes monitoring an eye movement information of the user in real time, and determining the sight of the user according to the eye movement information, in order to determine a pixel corresponding to the real point, that is, the pixel displaying the real point.

The augmented reality display method has been described in detail in the specific operation process of the augmented reality display device described above, and will not be described herein again.

As can be seen from the above technical solutions, the present disclosure has at least one of the following advantages and positive effects:

The present disclosure provides an augmented reality display device. An adjustable light transmissive sheet includes a plurality of pixels, the light transmission of each of the plurality of pixels can be controlled; the spatial three-dimensional reconstruction component can obtain the depth value of each real point of the real scene in the user's field of view; the control unit compares the depth value of the virtual point displayed in the same pixel with that of the real point, when the depth value of the real point is greater than that of the virtual point, the pixel is controlled to be opaque; when the depth value of the real point is smaller than that of the virtual point, the pixel is controlled to be transparent. In one aspect, by controlling the translucency of the pixels of the adjustable light-transmissive sheet, the virtual reality scene or the real scene is controlled to be displayed, and thus realizing the selective presentation of the real scene in the user's field of view without capturing the real scene and processing the image priority to the presentation to the user. In another aspect, the user can directly view the real scene, and thus prevent confusion of the user to determine the position caused by visual deviation. In yet another aspect, the real scene can be directly transmitted to the user through the adjustable light-transmissive sheet, and there is no delay of the real scene display, and a more realistic real scene can be obtained.

The features, structures, or characteristics described above may be combined in any suitable manner in one or more arrangements, and the features discussed in the various arrangements are interchangeable, if necessary. In the above description, numerous specific details are set forth to provide a thorough understanding of the arrangements of the disclosure. However, those skilled in the art will appreciate that the technical solutions of the present disclosure may be practiced without one or more of the specific details, or other methods, components, materials, and the like may be employed. In other instances, well-known structures, materials or operations are not shown or described in detail to avoid obscuring aspects of the present disclosure.

In the present specification, the terms “a”, “an”, “the”, “this” , “said”, and “at least one” are used to mean the inclusion of the open type and means that there may be additional elements/components/etc. in addition to the listed elements/components/etc.

It should be understood that the present disclosure does not limit to the detailed structure and arrangement of the components presented in the specification. The present disclosure can have other arrangements, and can be implemented and practiced with various forms. The foregoing variations and modifications are intended to fall within the scope of the present disclosure. It is to be understood that the disclosure disclosed and claimed herein extends to all alternative combinations of two or more individual features that are mentioned or apparent in the drawings. All of these different combinations constitute a number of alternative aspects of the present disclosure. The arrangements described in the specification are illustrative of the best mode of the present disclosure, and will enable those skilled in the art to utilize this disclosure.

1. An augmented reality display device comprising:
an adjustable light transmissive sheet including a plurality of pixels, light transmission of each of the plurality of pixels being controllable;
a spatial three-dimensional reconstruction portion, configured to obtain a depth value of each real point of a real scene in a field of view of a user; and
a controller, configured to compare a depth value of a virtual point displayed in a pixel with the depth value of the real point of the real scene corresponding to one of the plurality of pixels, when the depth value of the real point is greater than the depth value of the virtual point, the one of the plurality of pixels is controlled to be opaque; and when the depth value of the real point is smaller than the depth value of the virtual point, the pixel is controlled to be transparent,
wherein the spatial three-dimensional reconstruction portion comprises:
a light emitter, configured to emit light, the light being reflected by the real scene in the field of view of the user to form reflected light; and
an optical receiver, configured to receive the reflected light and determine the depth value of each real point of the real scene in the field of view of the user according to the reflected light,
wherein the light comprises structured light, and wherein the structured light comprises standard stripe or grid light.

2. The augmented reality display device of claim 1, further comprising:
a virtual scene generator electrically connected to the controller, and configured to not generate a virtual scene at the one of the plurality of pixels corresponding to the virtual point w hen the depth value of the real point is smaller than the depth value of the virtual point.

3-5. (canceled)

6. The augmented reality display device of claim 1, further comprising:
an eye movement information capture device, configured to monitor eye movement information of the user in real time; and
the controller is configured to determine a sight of the user according to the eye movement information, to determine a pixel corresponding to the real point.

7. The augmented reality display device of claim 1, further comprising:
a lens, configured to transmit the real scene and reflect a virtual scene to the user, the lens being attached to the adjustable light transmissive sheet.

8. The augmented reality display device of claim 7, wherein the adjustable light transmissive sheet comprises a liquid crystal light transmissive sheet.

9. An augmented reality glasses comprising:
an augmented reality display device; and
a frame and a temple,
wherein, the augmented reality display device comprises:
an adjustable light transmissive sheet, comprising a plurality of pixels, a light transmission of each of the plurality of pixels being controllable;
a spatial three-dimensional reconstruction portion, configured to obtain a depth value of each real point of a real scene in a field of view of a user; and
a controller, configured to compare a depth value of a virtual point displayed in a pixel with the depth value of the real point of the real scene corresponding to one of the plurality of pixels, when the depth value of the real point is greater than the depth value of the virtual point, the one of the plurality of pixels is controlled to be opaque; and when the depth value of the real point is smaller than the depth value of the virtual point, the one of the plurality of pixels is controlled to be transparent,
wherein, the adjustable light transmissive sheet is provided in the frame, the spatial three-dimensional reconstruction portion is provided on the frame, and the controller is provided at the temple,
wherein the spatial three-dimensional reconstruction portion comprises:
a light emitter, configured to emit light, the light being reflected by the real scene in the field of view of the user to form reflected light; and
an optical receiver, configured to receive the reflected light and determine the depth value of each real point of the real scene in the field of view of the user according to the reflected light,
wherein the light comprises a structured light, and wherein the structured light comprises a standard stripe or grid light.

10. The augmented reality glasses of claim 9, wherein the augmented reality display device further comprises:
a virtual scene generator electrically connected to the controller, and configured to not generate a virtual scene at the one of the plurality of pixels corresponding to the virtual point when the depth value of the real point is smaller than the depth value of the virtual point.

11-13. (canceled)

14. The augmented reality glasses of claim 9, wherein the augmented reality display device further comprises:
an eye movement information capture device, configured to monitor eye movement information of the user in real time; and
the controller is configured to determine a sight of the user according to the eye movement information, to determine a pixel corresponding to the real point.

15. The augmented reality glasses of claim 9, wherein the augmented reality display device further comprises:
a lens, configured to transmit the real scene and reflect a virtual scene to the user, the lens being attached to the adjustable light transmissive sheet.

16. The augmented reality glassed of claim 15, wherein the adjustable light transmissive sheet comprises a liquid crystal light transmissive sheet.

17. An augmented reality display method comprising:
obtaining a depth value of each real point of a real scene in a field of view of a user;
receiving a depth value of each virtual point of a virtual scene
comparing the depth value of the virtual point displayed in a pixel with the depth value of the real point of the real scene corresponding to the pixel, when the depth value of the real point is greater than the depth value of the virtual point, the pixel is controlled to be opaque; and when the depth value of the real point is smaller than the depth value of the virtual point, the pixel is controlled to be transparent,
wherein obtaining the depth value of each real point of the real scene in the field of view of the user comprises:
emitting light, the light being reflected by the real scene in the field of view of the user to form reflected light; and
receiving the reflected light and determining the depth value of each real point of the real scene in the field of view of the user according to the reflected light,
wherein the light comprises a structured light, and wherein the structured light comprises a standard stripe or grid light.

18. The augmented reality display method of claim 17, further comprising:
not generating a virtual scene at the pixel corresponding to the virtual point when the depth value of the real point is smaller than the depth value of the virtual point.

19. (canceled)

20. The augmented reality display method of claim 17, further comprising:
monitoring eye movement information of the user in real time, and determining a sight of the user according to the eye movement information, to determine a pixel corresponding to the real point.
